(19) United States
(12) Patent Application Publication
(10) Pub. No.: US 2023/0148367 A1
(43) Pub. Date: May 11, 2023

(54) SYSTEM AND METHOD FOR MULTI-MODE RECEIVER

(71) Applicant: TEXAS INSTRUMENTS INCORPORATED, Dallas, TX (US)

(72) Inventors: Harsh Dinesh JHAVERI, Wylie, TX (US); Mark WOLFE, Plano, TX (US)

(21) Appl. No.: 17/733,089

(22) Filed: Apr. 29, 2022

Related U.S. Application Data
(60) Provisional application No. 63/278,172, filed on Nov. 11, 2021.

(51) Int. Cl. H04B 1/16

(52) U.S. Cl. CPC H04B 1/16

(57) ABSTRACT

In accordance with at least one example of the description, a multimode (MM) receiver includes a single-ended mode (SEM) receiver, a differential mode (DM) receiver, and a MM input interface. The SEM receiver having a SEM input. The DM receiver having a first DM input and a second DM input. The SEM receiver and the DM receiver being configured to support different transmission modes. The MM input interface having a first MM input and a second MM input. The MM input interface adapted to be coupled to a driver. The first MM input coupled to the SEM input and the first DM input. The second MM input coupled to the second DM input.

### CROSS-REFERENCE TO RELATED APPLICATIONS

The present application claims priority to U.S. Provisional Patent Application No. 63/278,172, which was filed Nov. 11, 2021, is titled “Autodetecting Single-Ended And Differential Input Topology,” and is hereby incorporated herein by reference in its entirety.

### BACKGROUND

Different applications can involve using different transmission modes to communicate information (e.g., data and/or clock). Tradeoffs can exist between different transmission modes. For example, the different transmission modes can include a differential transmission mode and a single-ended transmission mode. Relative to the single-ended transmission mode, the differential transmission mode can provide applications with higher frequency transmissions, lower signal levels, higher noise immunity, and/or higher transmission distances. The differential transmission mode can involve higher circuit power relative to the single-ended transmission mode to provide such higher transmission distances. A broader range of applications can be supported by supporting multiple transmission modes.

### SUMMARY

In accordance with at least one example of the description, a multimode (MM) receiver includes a single-ended mode (SEM) receiver, a differential mode (DM) receiver, and a MM input interface. The SEM receiver having a SEM input. The DM receiver having a first DM input and a second DM input. The SEM receiver and the DM receiver being configured to support different transmission modes. The MM input interface having a first MM input and a second MM input. The MM input interface adapted to be coupled to a driver. The first MM input coupled to the SEM input and the first DM input. The second MM input coupled to the second DM input.

In accordance with at least one example of the description, a system includes a controller and a display device. The controller having a driver circuit. The display device having a first spatial light modulator (SLM) and a second SLM. The first SLM including a multimode (MM) receiver with a transmission mode (TM) detector coupled to the driver circuit. The TM detector is configured to set an operational mode of the MM receiver responsive to a transmission mode of a received input signal.

### BRIEF DESCRIPTION OF THE DRAWINGS

FIG. 1 is a block diagram of an example system for communicating information.

FIG. 2 is a diagram illustrating a differential transmission mode, in accordance with various examples.

FIG. 3 is a diagram of example waveforms showing voltage as a function of time.

FIG. 4 is a diagram of an example waveform showing voltage as a function of time.

FIG. 5 is a block diagram of an example implementation of a portion of a multimode receiver.

FIG. 6 is a schematic diagram of an example implementation of a transmission mode (TM) detector.

FIG. 7 is a schematic diagram of an example implementation of a TM detector.

FIG. 8 is a block diagram of an example implementation of a portion of a multimode receiver.

FIG. 9 is a block diagram of an example system that includes a multimode receiver.

FIG. 10 is a flow diagram of an example method for communicating information.

FIG. 11 is a block diagram of an imaging system, in accordance with various examples.

### DETAILED DESCRIPTION

As described above, supporting multiple transmission modes can facilitate supporting a broader range of applications. However, supporting multiple transmission modes can also involve supporting different input interfaces. Aspects of this description relate to a multimode receiver that supports multiple transmission modes. In at least one example, the multimode receiver can include a multimode input interface with one input (e.g., a shared input) coupled to different receivers that support different transmission modes (e.g., a single-ended transmission mode and a differential transmission mode. Coupling the shared input of the multimode input interface to different receivers that support different transmission modes can be useful to reduce pin count and/or die size. For example, supporting multiple transmission modes on a single input (e.g., the shared input) of the multimode input interface can facilitate avoiding pin count increases and/or die size increases associated with implementing different interfaces for different transmission modes to maintain separation between the different transmission modes. Coupling the shared input of the multimode input interface to different receivers that support different transmission modes can also be useful to support multiple transmission modes using a single integrated circuit or semiconductor die. Supporting multiple transmission modes using a single integrated circuit or semiconductor die via the shared input of the multimode input interface can facilitate avoiding costs associated with supporting multiple transmission modes using multiple integrated circuits, such as inventory control measure costs for managing different integrated circuits, or separate development/support costs for each different integrated circuit.

In at least one example, the multimode receiver can include a multimode input interface with one input (e.g., a detection input) coupled to a transmission mode detector and to one receiver among the different receivers of the multimode receiver. The transmission mode detector can be configured to automatically detect a transmission mode of an input signal received at the multimode input interface. Automatically detecting the transmission mode of the input signal by the transmission mode detector can be useful to adaptively set an operational mode of the multimode receiver responsive to the detected transmission mode. Adaptively setting an operational mode of the multimode receiver responsive to the detected transmission mode can be useful to provide increased design flexibility. Adaptively setting an operational mode of the multimode receiver responsive to the detected transmission mode can involve disabling different receivers of the multimode receiver in different operational modes to facilitate reducing power consumption within the multimode receiver.

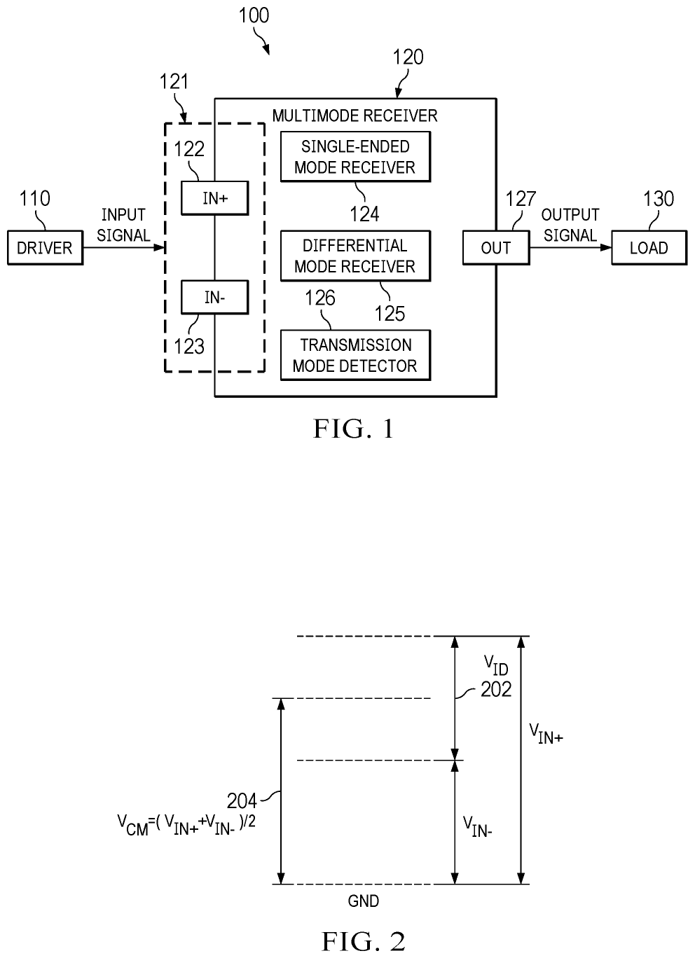

FIG. 1 is a block diagram of an example system 100 for communicating information (e.g., data or clock). At least some implementations of the system 100 are representative of an application environment for a multimode receiver with transmission mode autodetection to support multiple transmission modes on a shared input. The system 100 can include a driver 110 and a multimode receiver (MM receiver) 120 having a multimode input interface (MM input interface) 121 adapted to be coupled to the driver 110. The driver 110 may be implemented by a microcontroller, a processor, a microcomputer, digital circuitry, analog circuitry, field programmable gate array, an application specific integrated circuit, memory and/or software. The driver 110 can be connected to a single conductor or a multi-conductor bus to facilitate communications with the MM receiver 120. The MM input interface 121 can include a first multimode input (first MM input) 122 and a second multimode input (second MM input) 123. The MM receiver 120 can also include a single-ended mode (SEM) receiver 124, a differential mode (DM) receiver 125, a transmission mode detector (TM detector)126, and a multimode output (MM output) 127. The system 100 can also include a load 130 adapted to be coupled to the MM output 127. The MM receiver 120 can be configured to provide output signals at the MM output 127 that modify operation of the load 130 responsive to input signals (e.g., data signals and/or clock signals) received at the MM input interface 121 by the driver 110. In at least one example, a single integrated circuit implements the MM input interface 121, the SEM receiver 124, and the DM receiver 125.

In an example architecture of the system 100, one input (e.g., a shared input) of the MM input interface 121 can be coupled to both the SEM receiver 124 and the DM receiver 125. Coupling one input of the MM input interface 121 to both the SEM receiver 124 and the DM receiver 125 can be useful to support multiple transmission modes on a shared input. Another input (e.g., a detection input) of the MM input interface 121 can be coupled to both the TM detector 126 and the DM receiver 125. Coupling another input of the MM input interface 121 to both the TM detector 126 and the DM receiver 125 can be useful to adaptively set an operational mode of the MM receiver 120 responsive to a transmission mode of an input signal received at the MM input interface 121.

In an example operation of the system 100, an input signal (e.g., a data signal and/or a clock signal) transmitted by the driver 110 can be received at the MM input interface 121. The TM detector 126 is configured to automatically detect a transmission mode of the input signal received at the MM input interface 121 using a threshold voltage (V_{T}). In at least one example, the TM detector 126 can be configured to automatically detect the transmission mode of the input signal absent handshake-related signals being exchanged between the driver 110 and the MM receiver 120. In at least one example, V_{T} is an internal threshold voltage that is received by the MM receiver 120. Automatically detecting the transmission mode of the input signal at the MM receiver 120 can be useful to conserve bandwidth. For example, automatically detecting the transmission mode of the input signal at the MM receiver 120 can mitigate consumption of bandwidth by handshake-related signals exchanged between the driver 110 and the MM receiver 120.

Responsive to detecting the transmission mode of the input signal, the TM detector 126 can provide a receiver select signal (SEL signal) to a SEM control interface of the SEM receiver 124 and a DM control interface of the DM receiver 125. The SEL signal provided by the TM detector 126 sets an operational mode of the MM receiver 120. The SEL signal can set the operational mode of the MM receiver 120 to a first operational mode when the transmission mode detected by the TM detector 126 is a single-ended transmission mode supported by the SEM receiver 124. Setting the operational mode of the MM receiver 120 to the first operational mode can enable the SEM receiver 124 and disable the DM receiver 125. In the first operational mode, the SEM receiver 124 can be configured to provide an output signal at the MM output 127 based on the input signal received at the MM input interface 121. The SEL signal can set the operational mode of the MM receiver 120 to a second operational mode when the transmission mode detected by the TM detector 126 is a differential transmission mode supported by the DM receiver 125. Setting the operational mode of the MM receiver 120 to the second operational mode can enable the DM receiver 125 and disable the SEM receiver 124. In the second operational mode, the DM receiver 125 can be configured to provide an output signal at the MM output 127 based on the input signal received at the MM input interface 121. Disabling different receivers in different operational modes of the MM receiver 120 can be useful to reduce power consumption.

As described above, the TM detector 126 can be configured to automatically detect a transmission mode of an input signal received at the MM input interface 121 using V_{T}. Providing the TM detector 126 with V_{T} having a value that distinguishes one transmission mode from another transmission mode can be useful to support multiple transmission modes on a shared input of the MM receiver 120. Different transmission modes can involve driving a different number of inputs of the MM input interface 121 to communicate information (e.g., data or clock). Different transmission modes can also involve using different reference voltages to interpret communicated information. Such differences can be useful to distinguish one transmission mode from another transmission mode.

By way of example, a single-ended transmission mode (e.g., Low Voltage Complementary Metal-Oxide Semiconductor (LVCMOS) signaling) can involve driving one input (e.g., the first MM input 122) of the MM input interface 121 to communicate information (e.g., data or clock). In this example, the single-ended transmission mode can also involve using a fixed voltage reference (e.g., a ground voltage potential) applied to another input (e.g., the second MM input 123) of the MM input interface 121 to interpret communicated information.

As another example, a differential transmission mode (e.g., Low Voltage Differential Signaling (LVDS) and/or Sub-Low Voltage Differential Signaling (sub-LVDS)) can involve driving two inputs (e.g., the first MM input 122 and the second MM input 123) of the MM input interface 121 to communicate information (e.g., data or clock). With reference to FIG. 2, a voltage (V_{IN+}) driving the first MM input 122 and a voltage (V_{IN-}) driving the second MM input 123 can form an input signal (e.g., a differential input signal) having a differential component 202 and a common mode component 204. The differential component 202 can represent a voltage difference (V_{ID}) between V_{IN+} driving the first MM input 122 and V_{IN-} driving the second MM input 123. The common mode component 204 can be a voltage (V_{CM}) that is common to both the first MM input 122 and the second MM input 123. In at least one example, V_{CM} can be determined according to:

(V_{IN+}+V_{IN-})/2 (1)

The common mode component 204 can represent a voltage offset of the differential component 202 with respect to ground. In this example, the differential transmission mode can also involve using a value of V_{IN+} and a value of V_{IN-} to interpret communicated information. In at least one example, a value of V_{IN+} can be determined according to:

V_{CM}+|½*V_{ID}| (2)

In at least one example, a value of V_{IN-} can be determined according to:

V_{CM}−|½*V_{ID}| (3)

In at least one example, a value of V_{IN+} driving the first MM input 122 can vary between V_{CM}+|½*V_{ID}| and V_{CM}−|½*V_{ID}|. In at least one example, a value of V_{IN-} driving the second MM input 123 can vary between V_{CM}+|½*V_{ID}| and V_{CM}−|½*V_{ID}|.

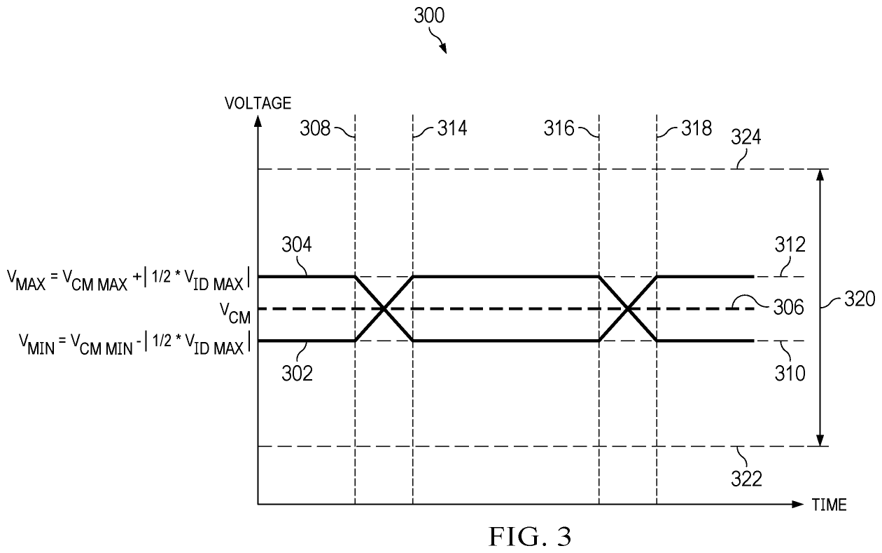

FIG. 3 is a diagram 300 of example waveforms that show temporal variance of input voltages driving two inputs (e.g., the first MM input 122 and the second MM input 123) of the MM input interface 121 to form an input signal. A transmission mode of the input signal formed in the diagram 300 can be a differential transmission mode. The diagram 300 includes waveforms 302 and 304. Waveform 302 corresponds to V_{IN+} as a function of time. Waveform 304 corresponds to V_{IN-} as a function of time. V_{ID} between waveforms 302 and 304 can correspond to a differential component (e.g., differential component 202 of FIG. 2) of the input signal shown in the diagram 300. The diagram 300 further includes V_{CM} 306 that can correspond to a common mode component (e.g., common mode component 204 of FIG. 2) of the input signal shown in the diagram 300.

Prior to time 308, V_{IN-} has a first value 310 and V_{IN+} has a second value 312 that exceeds the first value 310. When V_{IN+} exceeds V_{IN-}, the input signal shown in the diagram 300 can be in a first state (e.g., a high state). Between time 308 and time 314, V_{IN-} can transition from the first value 310 to the second value 312 and V_{IN+} can transition from the second value 312 to the first value 310. When V_{IN-} exceeds V_{IN+}, the input signal shown in the diagram 300 can be in a second state (e.g., a low state). Between time 316 and time 318, V_{IN-} can transition from the second value 312 to the first value 310 and V_{IN+} can transition from the first value 310 to the second value 312. The input signal shown in the diagram 300 can transition from the second state to the first state between time 316 and time 318.

The diagram 300 shows V_{IN+} and VIN transitioning within a range of values that extends between the first value 310 and the second value 312 to form the input signal. The differential transmission mode of the input signal shown in the diagram 300 can have an input voltage range 320 that extends beyond the first value 310 and the second value 312. In the diagram 300, a minimum input voltage (Vₘᵢₙ) 322 and a maximum input voltage (Vₘₐₓ) 324 can represent a lower bound and an upper bound of the input voltage range 320, respectively. V_{IN+} and/or V_{IN-} can transition within the input voltage range 320 to form the input signal shown in the diagram 300. In at least one example, a value of Vₘᵢₙ 322 can be determined according to:

V_{CM,min}−|½*V_{ID,max}| (4)

where V_{CM,min} and V_{ID,max} denote a minimum common mode voltage and a maximum voltage difference of the differential transmission mode of the input signal shown in the diagram 300, respectively. In at least one example, a value of Vₘₐₓ 324 can be determined according to:

V_{CM,max}+|½*V_{ID,max}| (5)

where V_{CM,max} denotes a maximum common mode voltage of the differential transmission mode of the input signal shown in the diagram 300. In at least one example, the differential transmission mode of the input signal shown in the diagram 300 can be LVDS. In this example, V_{CM,min} can have a value of about 1.125 volts and V_{ID,max} can have a value of about 0.6 volts. In at least one example, the differential transmission mode of the input signal shown in the diagram 300 can be sub-LVDS. In this example, V_{CM,min} can have a value of about 0.8 volts and V_{ID,max} can have a value of about 300 millivolts.

Providing V_{T} having a value based on the input voltage range 320 can be useful to distinguish the differential transmission mode of the input signal formed in the diagram 300 from another transmission mode (e.g., a single-ended transmission mode). In at least one example, a value of V_{T} based on the input voltage range 320 can be determined using one or more of Vₘᵢₙ 322, V_{CM,max}, and V_{ID,max}. In at least one example, a value of V_{T} based on the input voltage range 320 can be between Vₘᵢₙ 322 and a ground voltage potential. In at least one example, a value of V_{T} can be below Vₘᵢₙ 322 with Vₘᵢₙ 322 being determined according to equation (4).

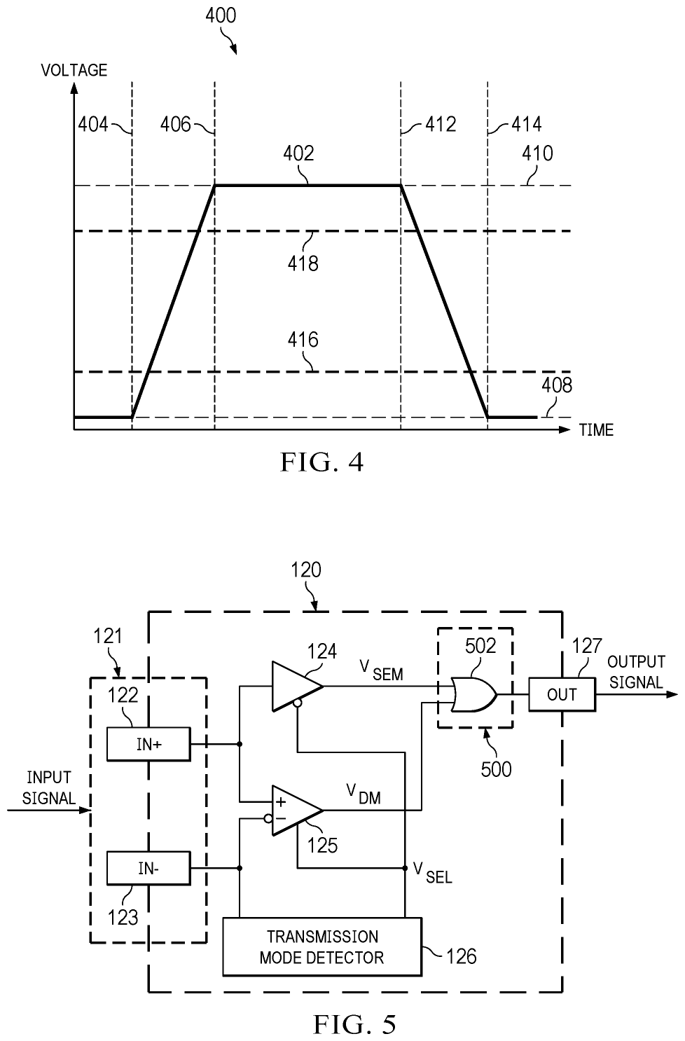

FIG. 4 is a diagram 400 of an example waveform 402 that shows temporal variance of an input voltage driving one input (e.g., the first MM input 122) of the MM input interface 121 to form an input signal. A transmission mode of the input signal formed in the diagram 400 can be a single-ended transmission mode. The input voltage driving the one input of the MM input interface 121 can be interpreted with respect to a fixed voltage reference (e.g., a ground voltage potential) applied to another input (e.g., the second MM input 123) of the MM input interface 121. Waveform 402 can correspond to V_{IN+} as a function of time. Between time 404 and time 406, V_{IN+} can transition from a first value 408 (e.g., a ground voltage potential of about 0 volts) to a second value 410 (e.g., a voltage (V_{DD}) provided by a voltage supply). Between time 412 and time 414, V_{IN+} can transition from the second value 410 to the first value 408. When V_{IN+} is below a third value 416 (e.g., about 0.3*V_{DD}), the input signal shown in the diagram 400 can be in a first state (e.g., a low state). When V_{IN+} is above a fourth value 418 (e.g., 0.8*V_{DD}), the input signal shown in the diagram 400 can be in a second state (e.g., a high state). When V_{IN+} is between the third value 416 and the fourth value 418, the input signal shown in the diagram 400 can be in a third state (e.g., an indeterminate state).

FIG. 5 is a block diagram of an example implementation of a portion of the MM receiver 120. In at least some examples, FIG. 5 is representative of a block-level implementation of, at least, a portion of the MM receiver 120 as shown in FIG. 1. For example, the MM receiver 120 as shown in FIG. 5 includes the MM input interface 121, the SEM receiver 124, the DM receiver 125, and the TM detector 126. In at least some examples, the first MM input 122 and the second MM input 123 can represent a shared input and a detection input of the MM input interface 121, respectively. In an example architecture of the MM receiver 120, the first MM input 122 can be coupled to both a SEM input of the SEM receiver 124 and a first DM input (e.g., a positive or non-inverting input) of the DM receiver 125. The second MM input 123 can be coupled to both a second DM input (e.g., a negative or inverting input) of the DM receiver 125 and a detector input of the TM detector 126. A detector output of the TM detector 126 can be coupled to a SEM control interface of the SEM receiver 124 and a DM control interface of the DM receiver 125.

In at least one example, the SEM control interface of the SEM receiver 124 and the DM control interface of the DM receiver 125 are coupled to a common enabling line. The SEL signal provided at the detector output of the TM detector 126 can drive the common enabling line. A voltage (V_{SEL}) of the SEL signal can be provided to the SEM control interface of the SEM receiver 124 and the DM control interface of the DM receiver 125 via the common enabling line. Coupling the SEM control interface of the SEM receiver 124 and the DM control interface of the DM receiver 125 to the detector output of the TM detector 126 via the common enabling line can be useful to enable one receiver (e.g., the SEM receiver 124) of the MM receiver 120 while disabling another receiver (e.g., the DM receiver 125) of the MM receiver 120.

In at least one example, an SEM output of the SEM receiver 124 and/or a DM output of the DM receiver 125 are adapted to be coupled to a logic circuit 500 of the MM receiver 120. In this example, the logic circuit 500 can be configured to set a state of an output signal provided at the MM output 127 responsive to a value of V_{SEM} provided at the SEM output of the SEM receiver 124 and a value of V_{DM} provided at the DM output of the DM receiver 125. In at least one example, the logic circuit 500 can include a logic gate 502. The logic gate 502 can be an OR logic gate or otherwise provide the functionality of an OR logical operation on a value of V_{SEM} provided at the SEM output of the SEM receiver 124 and/or a value of V_{DM} provided at the DM output of the DM receiver 125.

In an example operation of the MM receiver 120, an input signal (e.g., a data signal and/or a clock signal) can be received at the MM input interface 121. The input signal received at the MM input interface 121 can provide V_{IN+} at the first MM input 122 and V_{IN-} at the second MM input 123. Providing V_{IN+} at the first MM input 122 can provide V_{IN+} at the SEM input of the SEM receiver 124 and the first DM input of the DM receiver 125. Providing V_{IN-} at the second MM input 123 can provide V_{IN-} at the second DM input of the DM receiver 125 and at the detector input of the TM detector 126. Responsive to providing V_{IN-} at the detector input, the TM detector 126 can automatically detect a transmission mode of the input signal using V_{T} obtained by the MM receiver 120. In at least one example, V_{T} is an internal threshold voltage that is obtained by the MM receiver 120. In at least one example where V_{T} is an internal threshold voltage, V_{T} can be obtained by the MM receiver 120 using V_{REF} of a voltage divider of the TM detector 126 or using a gate-source voltage (V_{gs}) of a transistor of the TM detector 126, as described in greater detail below. In at least one example, the TM detector 126 can be configured to automatically detect the transmission mode of the input signal absent handshake-related signals being exchanged between the driver 110 and the MM receiver 120. The TM detector 126 can provide V_{SEL} at the detector output responsive to detecting the transmission mode of the input signal provided at the MM input interface 121. A value of V_{SEL} provided at the detector output can be provided at the SEM control interface of the SEM receiver 124 and the DM control interface of the DM receiver 125 to set an operational mode of the MM receiver 120.

For example, the transmission mode of the input signal can be a single-ended transmission mode when V_{IN-} provided at the detector input has a value at or below a value of V_{T} obtained by the MM receiver 120. The single-ended transmission mode can be supported by the SEM receiver 124. The TM detector 126 can provide V_{SEL} having a first value (e.g., a low value) at the detector output responsive to detecting the single-ended transmission mode. In this example, V_{SEL} having the first value can be provided at the SEM control interface of the SEM receiver 124 and the DM control interface of the DM receiver 125. Providing V_{SEL} having the first value at the SEM control interface and the DM control interface can enable (e.g., turn on) the SEM receiver 124 and disable (e.g., turn off) the DM receiver 125, respectively. Responsive to enabling the SEM receiver 124 and disabling the DM receiver 125, the operational mode of the MM receiver 120 can be a first operational mode. In the first operational mode, a SEM output of the SEM receiver 124 can provide a voltage (V_{SEM}) based on a value of V_{IN+} provided at the first MM input 122. A value of V_{SEM} provided at the SEM output can set a state of an output signal provided at the MM output 127 of the MM receiver 120 in the first operational mode.

As another example, the transmission mode of the input signal can be a differential transmission mode when V_{IN-} provided at the detector input has a value that exceeds a value of V_{T} obtained by the MM receiver 120. The differential transmission mode can be supported by the DM receiver 125. The TM detector 126 can provide V_{SEL} having a second value (e.g., a high value) at the detector output responsive to detecting the differential transmission mode. In this example, V_{SEL} having the second value can be provided at the SEM control interface of the SEM receiver 124 and the DM control interface of the DM receiver 125. Providing V_{SEL} having the second value at the SEM control interface and the DM control interface can disable (e.g., turn off) the SEM receiver 124 and enable (e.g., turn on) the DM receiver 125, respectively. Responsive to disabling the SEM receiver 124 and enabling the DM receiver 125, the operational mode of the MM receiver 120 can be a second operational mode. In the second operational mode, a DM output of the DM receiver 125 can provide a voltage (V_{DM}) based on a value of V_{IN+} provided at the first MM input 122 and the value of V_{IN-} provided at the second MM input 123. A value of V_{DM} provided at the DM output can set a state of an output signal provided at the MM output 127 of the MM receiver 120 in the second operational mode.

As described above, providing the TM detector 126 with V_{T} having a value that distinguishes one transmission mode from another transmission mode can be useful to support multiple transmission modes on a shared input of the MM receiver 120. Distinctions between different transmission modes can include driving a different number of inputs to communicate information (e.g., data or clock) and/or using different reference voltages to interpret communicated information. By way of example, providing the TM detector 126 with V_{T} having a value based on an input voltage range of a differential transmission mode can be useful to distinguish input signals of the differential transmission mode from input signals of another transmission mode (e.g., a single-ended transmission mode). In at least one example, the TM detector 126 can be provided with V_{T} having a value based on an input voltage range of a differential transmission mode where the input voltage range can be compatible with multiple transmission modes that include: LVCMOS, LVDS, and sub-LVDS.

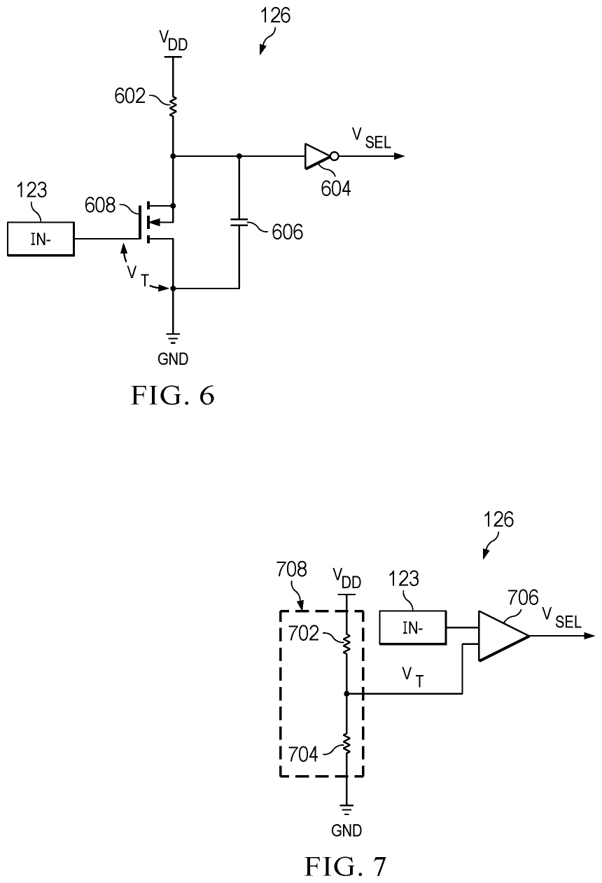

FIG. 6 is a schematic diagram of an example implementation of the TM detector 126. A gate-source voltage (V_{gs}) of transistors or semiconductor devices of a particular (e.g., desired) process technology can be below an input voltage range of a transmission mode (e.g., a differential transmission mode). For example, the transmission mode can be sub-LVDS where V_{CM,min} can have a value of about 0.8 volts and V_{ID,max} can have a value of about 300 millivolts. If determined according to equation (4), Vₘᵢₙ of the transmission mode can be about 0.65 volts. Semiconductor devices of the particular process technology can have V_{gs} values that are below Vₘᵢₙ (e.g., Vₘᵢₙ 322 of FIG. 3) of the transmission mode. Such devices can be useful to provide V_{T} having a value (e.g., 0.6 volts) that distinguishes input signals of the transmission mode from input signals of another transmission mode (e.g., a single-ended transmission mode).

In at least some examples, the TM detector 126 can include a resistor 602, an inverter 604, a capacitor 606, and a transistor 608 or other switching device, such as a field-effect transistor (FET), a metal-oxide-semiconductor field-effect transistor (MOSFET), or a bipolar junction transistor (BJT). The inverter 604 can be configured to control a polarity of the SEL signal provided at the SEM control interface of the SEM receiver 124 and the DM control interface of the DM receiver 125. In at least one example, the TM detector 126 lacks the inverter 604. In this example, the respective polarities shown in FIG. 6 for the SEM control interface of the SEM receiver 124 and the DM control interface of the DM receiver 125 can be transposed. The capacitor 606 can be configured to reduce or filter spurious signals (e.g., glitches) at the second MM input 123 responsive to an input signal being received at the MM input interface 121. In an example architecture of the TM detector 126, a gate of the transistor 608 can be coupled to IN− 123 of the MM input interface 121. In this example architecture, the second MM input 123 of the MM input interface 121 can represent a detection input of the MM receiver 120. As the detection input of the MM receiver 120, the second MM input 123 of the MM input interface 121 can be coupled to both the TM detector 126 and the DM receiver 125. A source of the transistor 608 can be coupled to ground and a first terminal of the capacitor 606. A drain of the transistor 608 can be coupled to a first terminal of the resistor 602, a second terminal of the capacitor 606, and an input of the inverter 604. A second terminal of the resistor 602 can be adapted to be coupled to V_{DD}.

In an example operation of the TM detector 126, V_{IN-} driving the second MM input 123 of the MM input interface 121 can be provided to the gate of the transistor 608 responsive to an input signal being received at the MM input interface 121. A value V_{IN-} driving the second MM input 123 relative to a gate-source voltage (V_{gs,608}) of the transistor 608 can control operation of the TM detector 126. In this example operation, V_{T} is an internal threshold voltage that is obtained by the TM detector 126 via V_{gs,608} of the transistor 608. A value of V_{gs,608} can be useful to provide the TM detector 126 with V_{T} having a value that distinguishes one transmission mode from another transmission mode.

For example, V_{IN-} driving the second MM input 123 can be provided by a fixed voltage reference (e.g., a ground voltage potential) when a transmission mode of the input signal is a single-ended transmission mode. In this example, the value of V_{IN-} can be a value (e.g., about 0 volts) of the fixed voltage reference. A value of V_{gs,608} can exceed the value of the fixed voltage reference providing V_{IN-} when the transmission mode of the input signal is the single-ended transmission mode. Responsive to the value of V_{gs,608} exceeding the value of the fixed voltage reference, the transistor 608 can be inactive (e.g., turned off). With the transistor 608 being inactive, V_{SEL} having a first value (e.g., a low value) can be provided at an output of the inverter 604. As described above, providing V_{SEL} having the first value can enable (e.g., turn on) the SEM receiver 124 and disable (e.g., turn off) the DM receiver 125, respectively. Responsive to enabling the SEM receiver 124 and disabling the DM receiver 125, the operational mode of the MM receiver 120 can be a first operational mode.

As another example, V_{IN-} driving the second MM input 123 can transition within an input voltage range (e.g., input voltage range 320 of FIG. 3) to form the input signal when a transmission mode of the input signal is a differential transmission mode. A value of V_{gs,608} can be below Vₘᵢₙ (e.g., Vₘᵢₙ 322 of FIG. 3) of the input voltage range such that a value of V_{IN-} exceeds the value of V_{gs,608}. Responsive to the value of V_{IN-} exceeding the value of V_{gs,608}, the transistor 608 can be active (e.g., turned on). With the transistor 608 being active, V_{SEL} having a second value (e.g., a high value) can be provided at the output of the inverter 604. As described above, providing V_{SEL} having the second value can enable (e.g., turn on) the DM receiver 125 and disable (e.g., turn off) the SEM receiver 124, respectively. Responsive to enabling the DM receiver 125 and disabling the SEM receiver 124, the operational mode of the MM receiver 120 can be a second operational mode.

FIG. 7 is a schematic diagram of another example implementation of the TM detector 126. V_{gs} of transistors or semiconductor devices of a particular (e.g., desired) process technology can be within an input voltage range of a transmission mode (e.g., a differential transmission mode). For example, the transmission mode can be LVDS where V_{CM,min} can have a value of about 1.125 volts and V_{ID,max} can have a value of about 0.6 volts. If determined according to equation (4), Vₘᵢₙ of the transmission mode can be about 0.825 volts. Semiconductor devices of the particular process technology can have V_{gs} values that exceed the Vₘᵢₙ of about 0.825 volts. With Vₘᵢₙ representing a lower bound of the input voltage range, V_{gs} values that exceed Vₘᵢₙ can be within the input voltage range of the transmission mode. V_{gs} values within the input voltage range of the transmission mode can be less than useful to provide the TM detector 126 with V_{T} having a value that distinguishes the transmission mode from another transmission mode. In such instances, the example implementation shown by FIG. 7 can be useful to provide V_{T} having a value (e.g., a value below Vₘᵢₙ of the input voltage range) that distinguishes input signals of the transmission mode from input signals of another transmission mode (e.g., a single-ended transmission mode). In at least one example, the transmission mode can be LVDS or sub-LVDS.

In at least some examples, the TM detector 126 can include a resistor 702, a resistor 704, and a comparator 706. In an example architecture of the TM detector 126, the resistor 702 can be coupled to the resistor 704 to form a voltage divider 708. The voltage divider 708 can be coupled between V_{DD} and ground. A first comparator input of the comparator 706 can be coupled between the resistor 702 and the resistor 704. A second comparator input of the comparator 706 can be coupled to the second MM input 123 of the MM input interface 121.

In an example operation of the TM detector 126, V_{IN-} driving the second MM input 123 can be provided to the second comparator input of the comparator 706 responsive to an input signal being provided at the MM input interface 121. A value V_{IN-} driving the second MM input 123 relative to a reference voltage (V_{REF}) of the voltage divider 708 can control operation of the TM detector 126. In this example operation, V_{T} is an internal threshold voltage that is obtained by the TM detector 126 via V_{REF} of the voltage divider 708. In at least one example, respective resistance values of the resistor 702 and the resistor 704 forming the voltage divider 708 can be useful to determine a value of V_{REF}. A value of V_{REF} can be useful to provide the TM detector 126 with V_{T} having a value that distinguishes one transmission mode from another transmission mode. In at least one example, a resistance value of the resistor 702 and/or a resistance value of the resistor 704 is an adjustable resistance value that can be useful to tune a value of V_{T} that is provided to the TM detector 126 by V_{REF} of the voltage divider 708.

V_{IN-} driving the second MM input 123 can be provided by a fixed voltage reference (e.g., a ground voltage potential) when a transmission mode of the input signal is a single-ended transmission mode. In this example operation, the value of V_{IN-} can be a value (e.g., about 0 volts) of the fixed voltage reference. A value of V_{REF} provided by the voltage divider 708 can exceed the value of the fixed voltage reference providing V_{IN-} when the transmission mode of the input signal is the single-ended transmission mode. Responsive to the value of V_{REF} exceeding the value of the fixed voltage reference, V_{SEL} having a first value (e.g., a low value) can be provided at a comparator output of the comparator 706. As described above, providing V_{SEL} having the first value can enable (e.g., turn on) the SEM receiver 124 and disable (e.g., turn off) the DM receiver 125, respectively. Responsive to enabling the SEM receiver 124 and disabling the DM receiver 125, the operational mode of the MM receiver 120 can be a first operational mode.

V_{IN-} driving the second MM input 123 can also transition within an input voltage range (e.g., input voltage range 320 of FIG. 3) to form the input signal when a transmission mode of the input signal is a differential transmission mode. A value of V_{REF} provided by the voltage divider 708 can be below Vₘᵢₙ (e.g., Vₘᵢₙ 322 of FIG. 3) of the input voltage range such that a value of V_{IN-} exceeds the value of V_{REF}. In at least one example, Vₘᵢₙ can be determined according to equation (4). Responsive to the value of V_{IN-} exceeding the value of V_{REF}, V_{SEL} having a second value (e.g., a high value) can be provided at the comparator output of the comparator 706. As described above, providing V_{SEL} having the second value can enable (e.g., turn on) the DM receiver 125 and disable (e.g., turn off) the SEM receiver 124, respectively. Responsive to enabling the DM receiver 125 and disabling the SEM receiver 124, the operational mode of the MM receiver 120 can be a second operational mode.

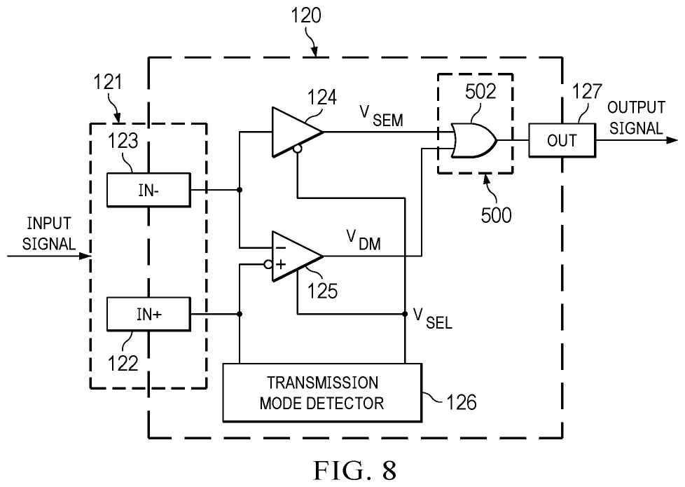

FIG. 8 is a block diagram of an example implementation of a portion of the MM receiver 120. In at least some examples, FIG. 8 is representative of a block-level implementation of, at least, a portion of the MM receiver 120 as shown in FIG. 1. For example, the MM receiver 120 as shown in FIG. 8 includes the MM input interface 121, the SEM receiver 124, the DM receiver 125, and the TM detector 126. In at least some examples, the first MM input 122 and the second MM input 123 can represent a detection input and a shared input of the MM input interface 121, respectively. In an example architecture of the MM receiver 120, the second MM input 123 can be coupled to both an SEM input of the SEM receiver 124 and a second DM input (e.g., a negative or inverting input) of the DM receiver 125. The first MM input 122 can be coupled to both a first DM input (e.g., a positive or non-inverting input) of the DM receiver 125 and a first detector input of the TM detector 126. A second detector input of the TM detector 126 can be coupled to V_{T}. A detector output of the TM detector 126 can be coupled to the SEM control interface of the SEM receiver 124 and the DM control interface of the DM receiver 125.

In an example operation of the MM receiver 120, an input signal (e.g., a data signal and/or a clock signal) can be received at the MM input interface 121. The input signal received at the MM input interface 121 can provide V_{IN+} at the first MM input 122 and V_{IN-} at the second MM input 123. Providing V_{IN-} at the second MM input 123 can provide V_{IN-} at the SEM input of the SEM receiver 124 and the second DM input of the DM receiver 125. Providing V_{IN+} at the first MM input 122 can provide V_{IN+} at the first DM input of the DM receiver 125 and the first detector input of the TM detector 126. Responsive to providing V_{IN+} at the first detector input, the TM detector 126 can automatically detect a transmission mode of the input signal using V_{T} provided at the second detector input. In at least one example, the TM detector 126 can be configured to automatically detect the transmission mode of the input signal absent handshake-related signals being exchanged between the driver 110 and the MM receiver 120. The TM detector 126 can provide V_{SEL} at the detector output responsive to detecting the transmission mode of the input signal provided at the MM input interface 121. A value of V_{SEL} provided at the detector output can be provided at the SEM control interface of the SEM receiver 124 and the DM control interface of the DM receiver 125 to set an operational mode of the MM receiver 120.

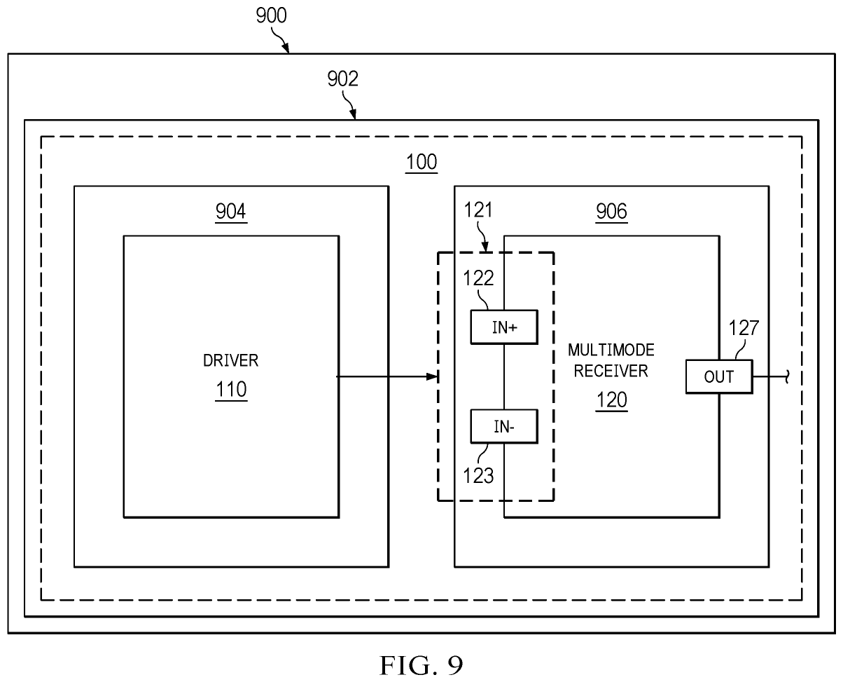

FIG. 9 is a block diagram of an example system 900 that includes the system 100 for communicating information (e.g., data or clock). At least some implementations of the system 900 are representative of application environments for the system 100, such as an automobile, an appliance, a personal electronic device, or other application environments that implement a system with a multimode receiver with transmission mode autodetection to support multiple transmission modes on a shared input. In at least some examples, the system 900 includes a printed circuit board 902 having a first semiconductor package 904 and a second semiconductor package 906. The printed circuit board 902 may include one or more conductors (e.g., traces) that couple the first semiconductor package 904 and the second semiconductor package 906. The printed circuit board 902 may include one or more conductors (e.g., traces) that couple the first semiconductor package 904, the second semiconductor package 906, and the load 130. The first semiconductor package 904 and the second semiconductor package 906 may each include one or more discrete semiconductor devices or integrated circuits that implement the driver 110 and the MM receiver 120, respectively.

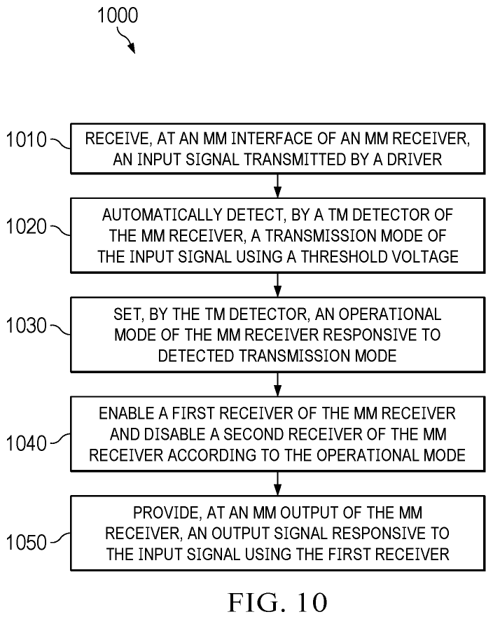

FIG. 10 is a block diagram of an example method 1000 for communicating information (e.g., data or clock). In at least one example, the method 1000 is performed within the system 100 by the MM receiver 120. At block 1010, a MM receiver receives, at an MM input interface, an input signal (e.g., a data signal and/or a clock signal) transmitted by a driver. At block 1020, a TM detector of the MM receiver automatically detects a transmission mode of the input signal using V_{T}. In at least one example, V_{T} is an internal threshold voltage that is obtained by the MM receiver, such as using V_{REF} of a voltage divider (e.g., voltage divider 708) of the TM detector or using a gate-source voltage (V_{gs}) of a transistor (e.g., transistor 608) of the TM detector. With V_{T} being an internal threshold voltage, the transmission mode of the input signal can be automatically detected by the TM detector absent handshake-related signals being exchanged between the driver and the MM receiver.

At block 1030, the TM detector sets an operational mode of the MM receiver responsive to the detected transmission mode. At block 1040, a first receiver of the MM receiver is enabled and a second receiver of the MM receiver is disabled according to the operational mode set in block 1030. The first receiver of the MM receiver supports the detected transmission mode. The second receiver of the MM receiver does not support the detected transmission mode. For example, the transmission mode detected by the TM detector can be a single-ended transmission mode supported by a SEM receiver of the MM receiver. In this example, the TM detector can set the operational mode of the MM receiver to a first operational mode. Setting the operation mode of the MM receiver to the first operational mode can involve enabling the SEM receiver and disabling a DM receiver of the MM receiver that does not support the single-ended transmission mode. As another example, the transmission mode detected by the TM detector can be a differential transmission mode supported by the DM receiver of the MM receiver. In this example, the TM detector can set the operational mode of the MM receiver to a second operational mode. Setting the operation mode of the MM receiver to the second operational mode can involve enabling the DM receiver and disabling the SEM receiver. Disabling the second receiver of the MM receiver that does not support the detected transmission mode can be useful to reduce power consumption. At block 1050, an MM output of the MM receiver provides an output signal responsive to the input signal received at the MM input interface using the first receiver.

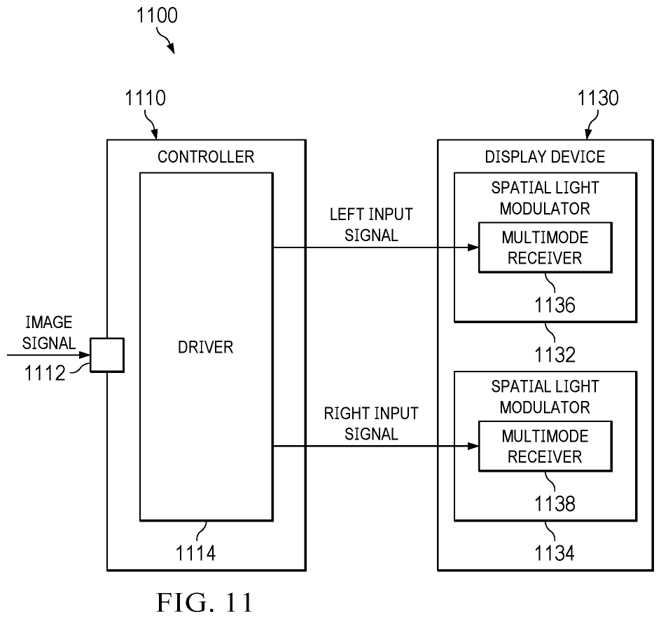

FIG. 11 is a block diagram of a projection system 1100, in accordance with various examples. The projection system 1100 may be part of the system 100. Implementing a MM receiver that supports multiple transmission modes in the projection system 1100 can be useful for a number of reasons. For example, implementing a MM receiver in the projection system 1100 can be useful to: reduce power consumption within the projection system 1100; reduce a pin count of a spatial light modulator (SLM) of the projection system 1100; reduce a die size of a SLM of the projection system 1100; avoid costs associated with inventory control measures for managing different types of receivers to support different transmission modes; and/or avoid separate development/support costs associated with providing different types of receivers, as described in greater detail below.

The projection system 1100 is configured to process image data for displaying respective images. The projection system 1100 can include a controller 1110 having an image input interface 1112 and a driver circuit 1114. The controller 1110 may be implemented by a microcontroller, a processor, a microcomputer, digital circuitry, analog circuitry, field programmable gate array, an application specific integrated circuit, memory and/or software. The image input interface 1112 can be configured to receive image (or video) signals that include the image data. In at least one example, the image input interface 1112 can include a wired communication interface (e.g., a high-definition multimedia interface (HDMI) interface, a display serial interface (DSI) interface, a flat panel display (FPD) interface, and/or a parallel red, green and blue (RGB) interface) and/or a wireless communication interface (e.g., a Wi-Fi interface and/or a Bluetooth interface).

The controller 1110 is configured to process the image data included in the image signals received at the image input interface 1112 to provide processed image data. The driver circuit 1114 can be connected to a multi-conductor bus 1120 to communicate with a display device 1130. The driver circuit 1114 is configured to communicate the processed image data to the display device 1130 for displaying respective images. The driver circuit 1114 can use different transmission modes to communicate the processed image data to the display device 1130 via the multi-conductor bus 1120. The different transmission modes can include a differential transmission mode (e.g., LVDS and/or sub-LVDS) and a single-ended transmission mode (e.g., LVCMOS).

The display device 1130 is configured to display stereoscopic images using the processed image data received via the multi-conductor bus 1120. For example, the display device 1130 may be a near-eye display, such as an augmented reality (AR) headset or a virtual reality (VR) headset. The processed image data received via the multi-conductor bus 1120 can be provided to an SLM, such as a digital mirror device (DMD), liquid crystal on silicon (LCOS), liquid crystal display (LCD), or a micro light-emitting diode (microLED), of the display device 1130 to display the stereoscopic images. To that end, the display device 1130 can include SLM 1132 and SLM 1134. The SLM 1132 can be configured to display left-eye images of the stereoscopic images. The SLM 1134 can be configured to display right-eye images of the stereoscopic images.

The SLM 1132 can include a MM receiver 1136 that supports multiple transmission modes, such as a differential transmission mode (e.g., LVDS and/or sub-LVDS) and a single-ended transmission mode (e.g., LVCMOS). The MM receiver 1136 can be configured to process left input signals transmitted by the driver circuit 1114 via the multi-conductor bus 1120. The left input signals can include a subset of the processed image data that corresponds to the left-eye images of the stereoscopic images. The MM receiver 1136 can be an example of the MM receiver 120. Accordingly, the MM receiver 1136 can include a MM interface, a SEM receiver, a DM receiver, and a TM detector, as described above with respect to the MM receiver 120. For example, the MM receiver 1136 can include a TM detector configured to automatically detect a transmission mode of a received left input signal received at a MM interface of the MM receiver 1136 using a threshold voltage. In this example, the TM detector can also be configured to set an operational mode of the MM receiver 1136 responsive to the detected transmission mode of the received left input signal. Setting the operational mode of the MM receiver 1136 can involve enabling one receiver (e.g., a SEM receiver) of the MM receiver 1136 that supports the detected transmission mode. The MM receiver 1136 can process the received left input signal using the enabled receiver. Setting the operational mode of the MM receiver 1136 can also involve disabling another receiver (e.g., a DM receiver) of the MM receiver 1136 that does not support the detected transmission mode.

The SLM 1134 can include a MM receiver 1138 that supports multiple transmission modes, such as a differential transmission mode (e.g., LVDS and/or sub-LVDS) and a single-ended transmission mode (e.g., LVCMOS). The MM receiver 1138 can be configured to process right input signals transmitted by the driver circuit 1114 via the multi-conductor bus 1120. The right input signals can include a subset of the processed image data that corresponds to the right-eye images of the stereoscopic images. The MM receiver 1138 can be an example of the MM receiver 120. Accordingly, the MM receiver 1138 can include a MM interface, a SEM receiver, a DM receiver, and a TM detector, as described above with respect to the MM receiver 120. For example, the MM receiver 1138 can include a TM detector configured to automatically detect a transmission mode of a received right input signal received at a MM interface of the MM receiver 1138 using a threshold voltage. In this example, the TM detector can also be configured to set an operational mode of the MM receiver 1138 responsive to the detected transmission mode of the received right input signal. Setting the operational mode of the MM receiver 1138 can involve enabling one receiver (e.g., a DM receiver) of the MM receiver 1138 that supports the detected transmission mode. The MM receiver 1138 can process the received right input signal using the enabled receiver. Setting the operational mode of the MM receiver 1138 can also involve disabling another receiver (e.g., a SEM receiver) of the MM receiver 1138 that does not support the detected transmission mode.

In at least one example, a first distance (e.g., about 15 centimeters (cm)) between the SLM 1132 and the driver circuit 1114 can be less than a second distance (e.g., about 40 cm) between the SLM 1134 and the driver circuit 1114. In this example, the driver circuit 1114 can transmit the left input signals to the MM receiver 1136 using a single-ended transmission mode (e.g., LVCMOS) and transmit the right input signals to the MM receiver 1138 using a differential transmission mode (e.g., LVDS and/or sub-LVDS). Transmitting signals using the single-ended transmission mode may consume less power than transmitting signals using the differential transmission mode. Accordingly, transmitting the left input signals to the MM receiver 1136 using the single-ended transmission mode instead of the differential transmission mode can be useful to reduce power consumption within the projection system 1100.

In at least one example, the MM receiver 1136 and the MM receiver 1138 can each be implemented using the same MM receiver (e.g., the MM receiver 120). Implementing the MM receiver 1136 and the MM receiver 1138 using the same type of MM receiver can facilitate avoiding the inventory control measures and/or separate development/support costs described above with respect to supporting multiple transmission modes using multiple integrated circuits.

As described above, the MM receiver 120 can facilitate avoiding pin count increases and/or die size increases associated with supporting multiple transmission modes using a single integrated circuit with different interfaces for different transmission modes. Implementing the MM receiver 1136 using the MM receiver 120 can be useful to avoiding such pin count increases and/or die size increases in the SLM 1132. Stated differently, implementing the MM receiver 1136 using the MM receiver 120 can be useful to reduce pin count and/or die size of the SLM 1132. Implementing the MM receiver 1138 using the MM receiver 120 can be useful to avoiding such pin count increases and/or die size increases in the SLM 1134. Stated differently, implementing the MM receiver 1138 using the MM receiver 120 can be useful to reduce pin count and/or die size of the SLM 1134.

The term “couple” is used throughout the specification. The term may cover connections, communications, or signal paths that enable a functional relationship consistent with this description. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While certain components may be described herein as being of a particular process technology, these components may be exchanged for components of other process technologies. Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground voltage potential” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means +/− 10 percent of the stated value. Modifications are possible in the described examples, and other examples are possible within the scope of the claims.

What is claimed is:

1. A multimode (MM) receiver comprising:
a single-ended mode (SEM) receiver having a SEM input;
a differential mode (DM) receiver having a first DM input and a second DM input, wherein the SEM receiver and the DM receiver are configured to support different transmission modes; and
an MM input interface having a first MM input and a second MM input, the MM input interface adapted to be coupled to a driver, the first MM input coupled to the SEM input and the first DM input, and the second MM input coupled to the second DM input.

2. The MM receiver of claim 1, wherein the SEM receiver is configured to support a single-ended transmission mode and the DM receiver is configured to support a differential transmission mode.

3. The MM receiver of claim 1, wherein a single integrated circuit implements the MM input interface, the SEM receiver, and the DM receiver.

4. The MM receiver of claim 1, wherein the SEM receiver and the DM receiver are coupled to a common enabling line.

5. The MM receiver of claim 1, further comprising:
a transmission mode (TM) detector having a detector input, the detector input coupled to the MM input interface, the TM detector configured to automatically detect a transmission mode of an input signal received at the MM input interface using a threshold voltage.

6. The MM receiver of claim 5, wherein the TM detector is further configured to set an operational mode of the MM receiver responsive to the detected transmission mode of the input signal.

7. The MM receiver of claim 5, wherein the detector input of the TM detector is coupled to the second MM input of the MM input interface.

8. A multimode (MM) receiver comprising:
a single-ended mode (SEM) receiver having a SEM input, the SEM receiver configured to support a single-ended transmission mode;
a differential mode (DM) receiver having a first DM input and a second DM input, the first DM input coupled to the SEM input, the DM receiver configured to support a differential transmission mode; and
a transmission mode (TM) detector having a detector input coupled to the second DM input of the DM receiver, the TM detector configured to automatically detect a transmission mode of a received input signal using a threshold voltage.

9. The MM receiver of claim 8, wherein the TM detector is further configured to enable the SEM receiver and disable the DM receiver responsive to the detected transmission mode of the received input signal being the single-ended transmission mode.

10. The MM receiver of claim 8, wherein the TM detector is further configured to enable the DM receiver and disable the SEM receiver responsive to the detected transmission mode of the received input signal being the differential transmission mode.

11. The MM receiver of claim 8, further comprising an MM input coupled to the detector input and to the second DM input, wherein the TM detector is further configured to automatically detect the transmission mode of the received input signal using a voltage received at the MM input.

12. The MM receiver of claim 8, wherein a value of the threshold voltage is based on an input voltage range of the differential transmission mode.

13. The MM receiver of claim 8, further comprising an MM input coupled to the detector input and to the second DM input, wherein the TM detector includes a transistor having a gate coupled to the MM input.

14. The MM receiver of claim 13, wherein a gate-source voltage of the transistor provides the threshold voltage.

15. The MM receiver of claim 8 further comprising a MM input coupled to the detector input and the second DM input, wherein the TM detector includes a comparator having a first comparator input coupled to the MM input.

16. The MM receiver of claim 15, wherein the comparator includes a second comparator input coupled to a voltage divider, and wherein a reference voltage of the voltage divider provides the threshold voltage.

17. A system comprising:
a first spatial light modulator (SLM) comprising a multimode (MM) receiver comprising a transmission mode (TM) detector, the TM detector configured to:
receive an input signal from a driver circuit; and
determine an operational mode of the MM receiver responsive to a transmission mode of the input signal; and
a second SLM adapted to be coupled to the driver circuit.

18. The system of claim 17, wherein the MM receiver is a first MM receiver, and the second SLM comprises a second MM receiver adapted to be coupled to the driver circuit.

19. The system of claim 18, further comprising a controller comprising the driver circuit, wherein the driver circuit is configured to transmit the input signal to the first MM receiver using a first transmission mode and to transmit a different input signal to the second MM receiver using a second transmission mode, and wherein the first transmission mode and the second transmission mode are different transmission modes.

20. The system of claim 17, further comprising a near-eye display that comprises the first SLM and the second SLM.
